(19) United States
(12) Patent Application Publication
(10) Pub. No.: US 2016/0082447 A1
(43) Pub. Date: Mar. 24, 2016

(54) SHOWERHEAD WITH OSCILLATING WATER

(71) Applicants: Huasong ZHOU, Xiamen (CN); XIAMEN SOLEX HIGH-TECH INDUSTRIES CO., LTD., Xiamen (CN)

(72) Inventors: Hailang GONG, Xiamen (CN); Renbang LIN, Xiamen (CN); Shigang WANG, Xiamen (CN); Huasong ZHOU, Xiamen (CN)

(73) Assignees: XIAMEN SOLEX HIGH-TECH INDUSTRIES CO., LTD., Xiamen (CN); Huasong ZHOU, Xiamen (CN)

(21) Appl. No.: 14/592,350

(22) Filed: Jan. 8, 2015

(30) Foreign Application Priority Data
Sep. 23, 2014 (CN) 201420550451.8

(51) Int. Cl. B05B 1/02; E03C 1/04; F15D 1/00

(52) U.S. Cl. CPC B05B 1/02; F15D 1/0015; E03C 1/0404

(57) ABSTRACT

A showerhead with oscillating water includes an inlet passage connected to an outlet passage and an oscillator assembled inside the shower head. The oscillator has a main body with an inlet, a ball shaped oscillating cavity, and an outlet. The ratio of the inner diameter of the inlet, the inner diameter of the oscillating cavity and the minimum inner diameter of the outlet is 1:2.5-5:1.1-1.35. The water of the inlet flowing into the oscillating cavity divides into a main waterway and a feedback waterway, water of the main waterway flowing out of the outlet through the oscillating cavity, water of the feedback waterway flows back to the inlet through the cavity wall of the oscillating cavity, water of the main waterway flows out of the outlet in a circumferential cyclical shaking way under the compact of the water of the feedback waterway.

### FIELD OF THE INVENTION

The present invention relates to a showerhead with oscillating water.

### BACKGROUND OF THE INVENTION

Some existing showerheads are provided without oscillating water effect, some may have, but as the oscillator has complicated structure and large size, it is not applicable to small size showerhead, and the spray vigor is weak. A showerhead with oscillating water is disclosed in the Chinese patent database with publishing number CN2173662, therein, the ratio of the inner diameter of inlet hole, the inner diameter of the oscillating cavity, the inner diameter of the outlet hole of the shower head is 1:20:3 or 2:20:3, as the ratio of the cavity and the inlet hole is high, so that it has large size, long cavity route, high loss in energy, thus making it with low oscillating frequency and weak spray vigor. Besides, existing known oscillator needs high water pressure to start, so that it is unavailable in low water pressure area.

### SUMMARY OF THE INVENTION

The present invention is provided with a shower head with oscillating water that overcomes the disadvantages of the existing known technology.

The technical proposal of the present invention to solve the technical problem is that: Showerhead with oscillating water, comprising:

an inlet passage,

an outlet passage connected to the inlet passage,

an oscillator assembled inside the shower head, said oscillator having A shake water component, comprising a main body (10) with an inlet (11), a ball shaped oscillating cavity (12) and an outlet (13) that are connected one by one, wherein the ratio of the inner diameter of the inlet (11), the inner diameter of the oscillating cavity (12) and the minimum inner diameter of the outlet (13) is being 1:2.5-5:1.1-1.35, water of the inlet (11) flowing into the oscillating cavity (12) scatters scattering and divides dividing into a main waterway and a feedback waterway, water of the main waterway flows flowing out of the outlet (13) through the oscillating cavity (12), water of the feedback waterway flows flowing back to the inlet (11) through the cavity wall of the oscillating cavity (12), water of the main waterway flows flowing out of the outlet (13) in a circumferential cyclical shaking way under the compact of the water of the feedback waterway,

the inlet (11) is connected to the inlet passage, the outlet (13) is connected to the outlet passage.

In another preferred embodiment, the in ratio of the inner diameter of the inlet (11), the inner diameter of the shake cavity (12) and the minimum inner diameter of the outlet (13) is 1:3:1.2.

In another preferred embodiment, the inlet (11) is straight tube shaped, the inner diameter of the outlet (13) is gradually increased along the outlet direction, the inner diameter of the outlet (13) near to the shake cavity (12) is larger than the inner diameter of the inlet (11).

In another preferred embodiment, the connecting portion of the inlet (11) near to the oscillating cavity (12) connected to the oscillating cavity (12) is disposed with circular transition.

In another preferred embodiment, the main body (10) comprising a top body (15) and a bottom body (16) that form the oscillating cavity (12), the inlet (11) is disposed in the top body (15), the outlet (13) is disposed in the bottom body (16).

In another preferred embodiment, the top body (15) is disposed with a groove (17), the bottom body (16) is disposed with a boss (18), the boss (18) is inserted into the groove (17), the bottom surface of the groove (17) is tightly contacted with the top surface of the boss (18).

In another preferred embodiment, the side wall of the groove (17) is disposed with a lock groove (20), the side surface of the boss (18) is disposed with a lock block (30) coupled to the lock groove (20) to lock to the lock groove (20), with the lock connection of the lock groove (20) and the lock block (30), the top body (15) is assembled to the bottom body (16).

In another preferred embodiment, the inner diameter of the inlet (11) is 1.2-3.5 mm.

In another preferred embodiment, it comprises at least two oscillators that are ring array arranged.

In another preferred embodiment, the oscillator is disposed inside the faceplate (60) of the shower head, the main body (10) comprise a bottom body (16) and a top body (15), the bottom body (16) and the faceplate (60) are in integral forming directly, the corresponding top body (15) of the oscillator is embedded to the bottom body (16) to form a shower head with shake oscillating water outlet function.

In another preferred embodiment, the faceplate (60) of the shower head is disposed with a ring cavity (61), the bottom body (16) with a plurality of oscillators are ring array arranged inside the ring cavity (61) and are in integral forming formed, the a periphery wall of the bottom body (16) extends upwardly to form an accommodating room space of the top body (15), the top body (15) is embedded in the accommodating space.

In another preferred embodiment, the oscillating cavity (12) is formed between the top body (15) and the bottom body (16), the inlet (11) is disposed in the top body (15), the outlet (13) is disposed in the bottom body (16), the an front end of the outlet (13) is concaved and disposed on the an outlet surface (62) of the faceplate (60).

Compared to the existing known technology, the technical proposal of the present invention has following advantages:

1. The ratio of the inner diameter of the inlet, the inner diameter of the oscillating cavity and the minimum inner diameter of the outlet is 1:2.5-5:1.1-1.35. As the ratio of the inner diameter of the oscillating cavity and the inner diameter of the inlet is low, the oscillator can be made small, the route of the feedback waterway is small, so that it has low loss in energy, well oscillating effect, high oscillating frequency of the main waterway and strong spray vigor.

2. Preferred, the ratio of the inner diameter of the inlet, the inner diameter of the oscillating cavity and the minimum inner diameter of the outlet 13 is 1:3:1.2. At this time, it has well oscillating effect, high oscillating frequency and strong spray vigor.

3. As the connecting portion of the inlet near to the oscillating cavity connected to the oscillating cavity is disposed with circular transition, water slows down when flowing from the inlet to the circular transition portion, thus improving the scattering in the oscillating cavity.

4. The main body comprises the top body and the bottom body, the ball shaped oscillating cavity is formed between the top body and the bottom body, so that it is simple structural and easy to design the mould, and the inner surface of the oscillating cavity is smooth, thus making the oscillating effect well.

5. The inner diameter of the inlet 11 is 1.2-3.5 mm. As the oscillating cavity and the inner diameter of the outlet are relatively small, it can achieve well oscillating effect even in small water pressure, it is available in shower head.

### BRIEF DESCRIPTION OF THE DRAWINGS

The present invention will be further described with the drawings and the embodiments.

FIG. 1 illustrates a schematic diagram of an oscillator of an embodiment of the present invention.

FIG. 2 illustrates an exploded and schematic diagram of the oscillator of the embodiment.

FIG. 3 illustrates a first state of the oscillator of the embodiment.

FIG. 4 illustrates a second state of the oscillator of the embodiment.

FIG. 5 illustrates a third state of the oscillator of the embodiment.

FIG. 6 illustrates a sectional diagram of a shower head applied with the oscillator of a first embodiment.

FIG. 7 illustrates a schematic diagram of a shower head applied with the oscillator of a second embodiment.

FIG. 8 illustrates an exploded and schematic diagram of the faceplate of the shower head applied with the oscillator and the oscillator of the second embodiment.

FIG. 9 illustrates a schematic diagram of the faceplate of the shower head applied with the oscillator of the second embodiment.

FIG. 10 illustrates a sectional diagram of C-C of FIG. 9.

### DETAILED DESCRIPTION OF THE EMBODIMENTS

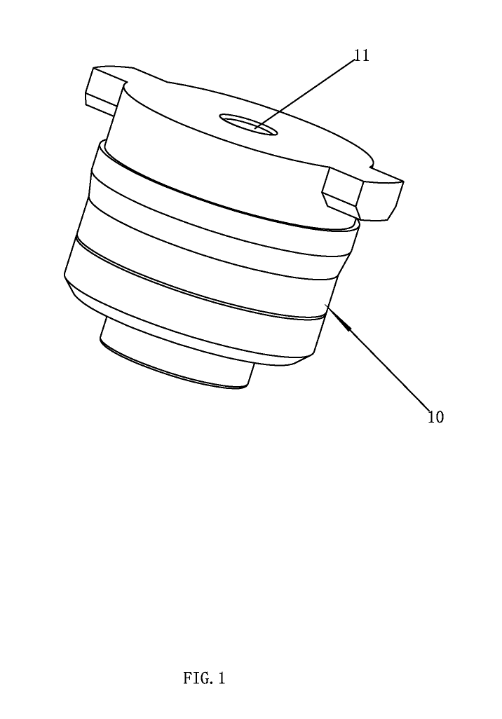

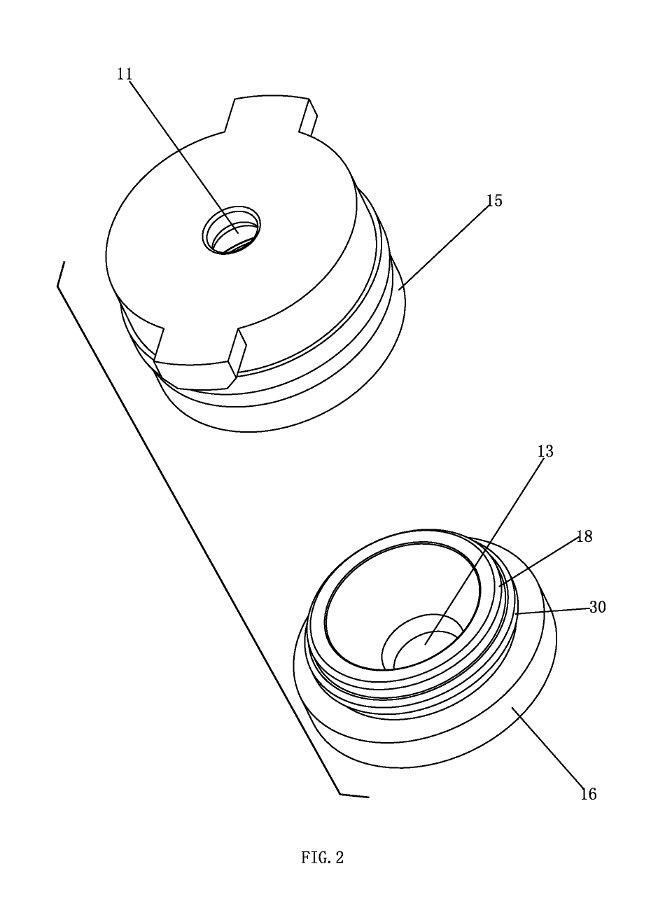

Referring to FIG. 1 to FIG. 5, an oscillator of an embodiment comprises a main body 10, the main body 10 is disposed with an inlet 11, a ball shaped oscillating cavity 12 and an outlet 13 that are connected one by one.

The main body 10 comprises a top body 15 and a bottom body 16, the top body 15 is disposed with a groove 17, the bottom body 16 is disposed with a boss 18, the boss 18 is inserted into the groove 17, the bottom surface of the groove 17 is tightly contacted with the top surface of the boss 18, the oscillating cavity 12 is formed between the top body 15 and the bottom body 16, the inlet 11 is disposed in the top body 15, the outlet is disposed in the bottom body 16. The main body comprises the top body and the bottom body, the ball shaped oscillating cavity is formed between the top body and the bottom body, so that it is simple structural and easy to design the mould, and the inner surface of the oscillating cavity is smooth, thus making the oscillating effect well.

In this embodiment, the side wall of the groove 17 is disposed with a lock groove 20, the side surface of the boss 18 is disposed with a lock block 30 coupled to the lock groove 20 to lock to the lock groove 20, with the lock groove 20 and the lock block 30, the top body 15 is assembled to the bottom body 16.

The ratio of the inner diameter of the inlet 11, the inner diameter of the oscillating cavity 12 and the minimum inner diameter of the outlet 13 is 1:2.5-5:1.1-1.35, water of the inlet 11 flowing into the oscillating cavity 12 scatters and divides into a main waterway and a feedback waterway, water of the main waterway flows out of the outlet 13 through the oscillating cavity 12, water of the inlet 11 water of the feedback waterway flows back to the inlet 11 through the cavity wall of the shack cavity 12, water of the main waterway flows out of the outlet 13 in a circumferential cyclical shaking way under the compact of the water of the feedback waterway. As the ratio of the inner diameter of the oscillating cavity and the inner diameter of the inlet is small, the oscillator can be made small, the route of the feedback waterway is short, so that it has low loss in energy, well oscillating effect, high oscillating frequency of the main waterway and strong spray vigor.

Preferred, the ratio of the inner diameter of the inlet 11, the inner diameter of the oscillating cavity 12 and the minimum inner diameter of the outlet 13 is 1:3:1.2. At this time, it has well oscillating effect, high oscillating frequency and strong spray vigor.

In this embodiment, the inlet 11 is straight tube shaped, the inner diameter of the outlet is gradually increased, the diameter of the end of the outlet 13 near to the oscillating cavity 12 is larger than the inner diameter of the inlet 11.

In this embodiment, the connecting portion of the inlet 11 near to the oscillating cavity 12 connected to the oscillating cavity 12 is disposed with circular transition. As the connecting portion of the inlet near to the oscillating cavity connected to the oscillating cavity is disposed with circular transition, water slows down when flowing from the inlet to the circular transition portion, thus improving the scattering in the oscillating cavity.

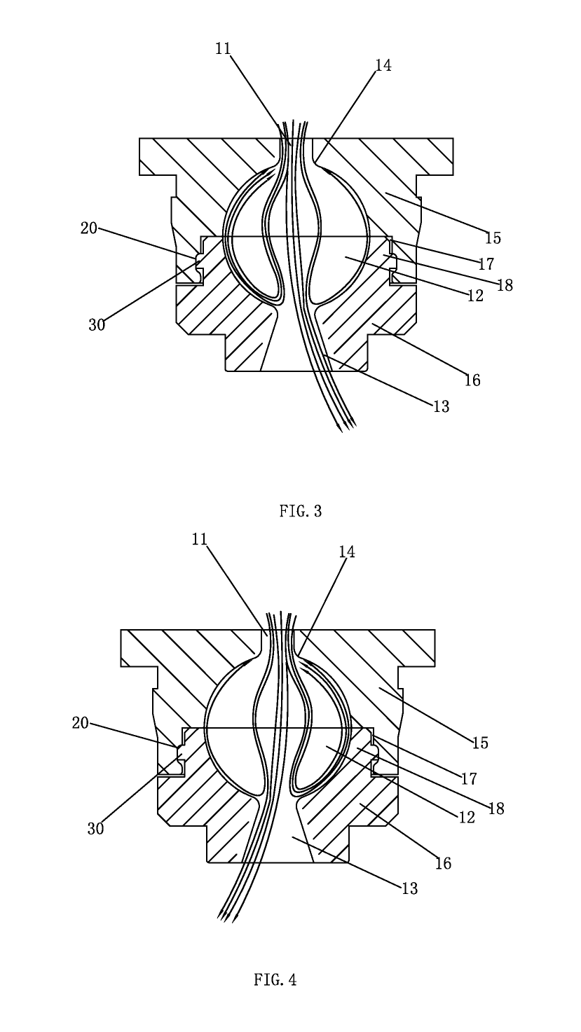

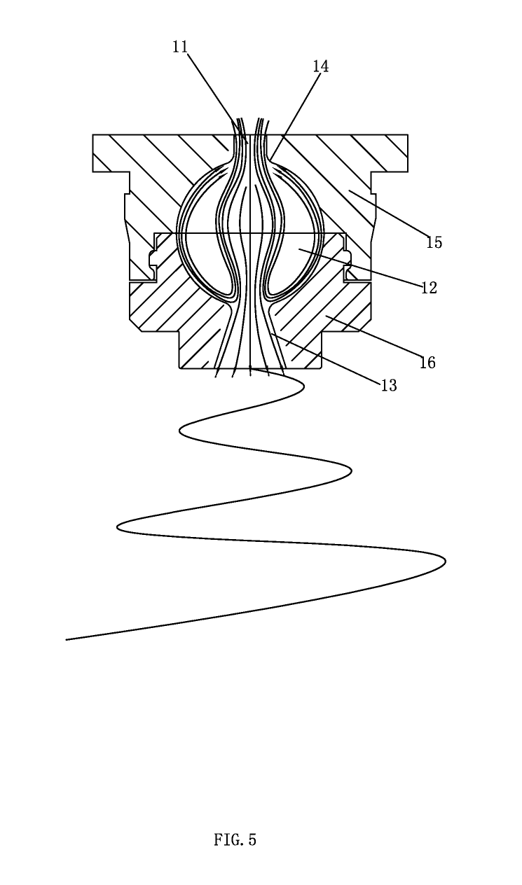

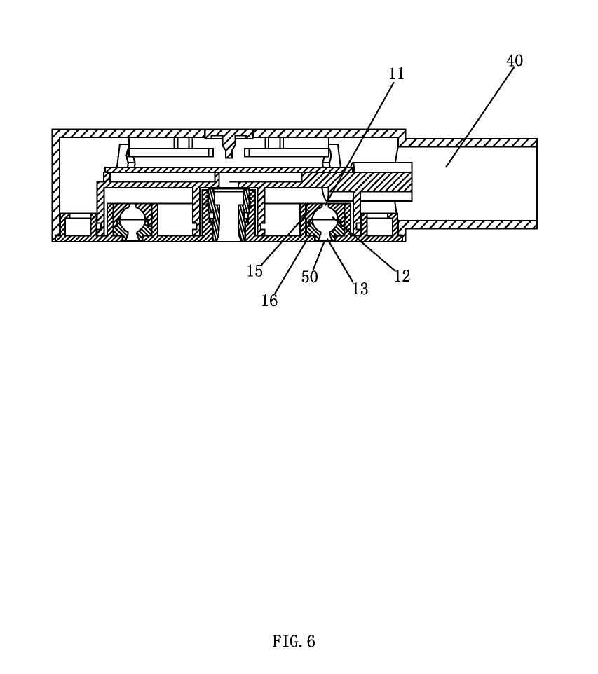

As figured in FIG. 3, when the flowing volume of the left feedback waterway is larger than the flowing volume of the right feedback waterway, the water of the main waterway is impacted by the water of the left feedback waterway and thus flowing right, and then flowing out from the inclined surface of the outlet; as figured in FIG. 4, when the flowing volume of the right feedback waterway is larger than the flowing volume of the left feedback waterway, the water of the main waterway is impacted by the water of the right feedback waterway and thus flowing left, and then flowing out from the inclined surface of the outlet. Due to the instability of the flowing, water stops in a position of the outlet and then inclines to other position the next moment, so that it has a circumferential cyclical shaking effect as figured in FIG. 5.

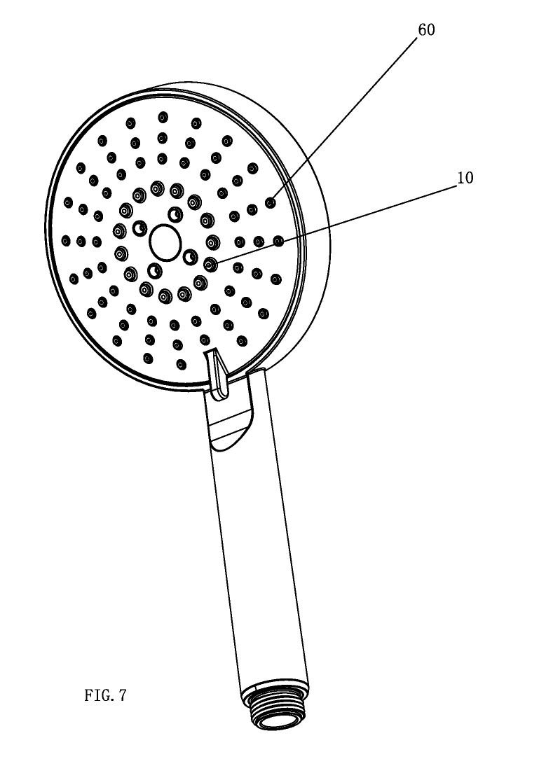

As figured in FIG. 6, disclosed is a first embodiment of a shower head applied with above said oscillator, the shower head is disposed with an inlet passage 40 and an outlet passage 50 connected to the inlet passage 40, the oscillators are disposed in the shower head, the inlet 11 is connected to the inlet passage 40, the outlet 13 is connected to the outlet passage 50.

Preferred, the inner diameter of the inlet 11 is 1.2-3.5 mm. As the oscillating cavity and the inner diameter of the outlet are relatively small, it can achieve well oscillating effect even in small water pressure, for example, even lower than 0.05 MPa, the oscillating component can have oscillating effect, it is available in shower head, so that the products can satisfy most area's needs. Preferred, there are more than two oscillators that are ring array arranged.

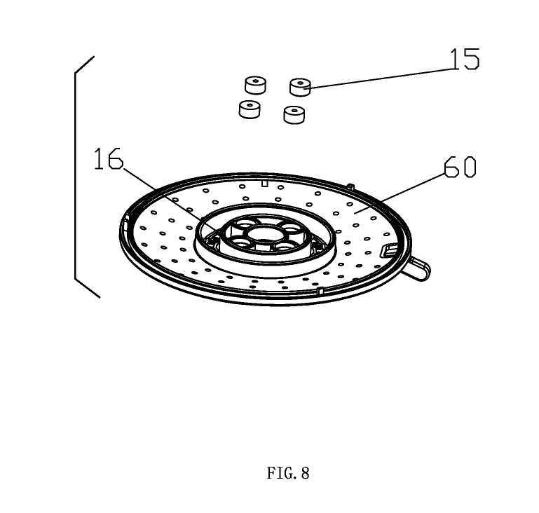

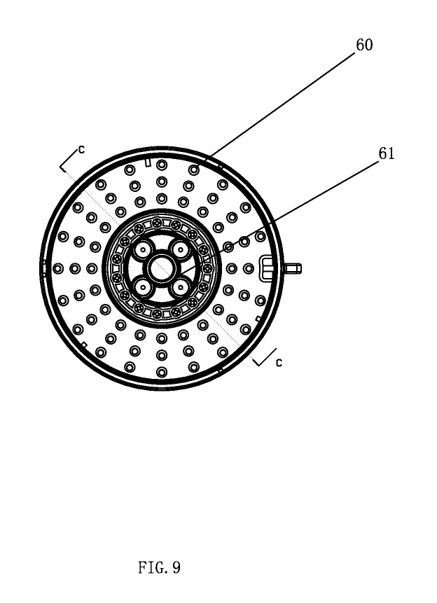

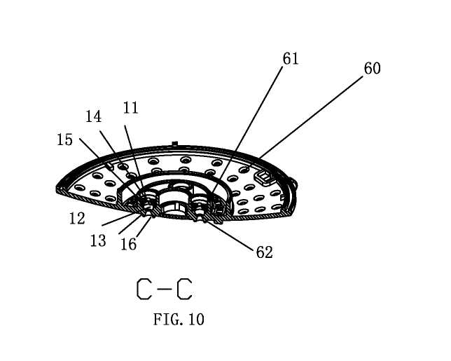

As figured in FIG. 7, FIG. 8, FIG. 9 and FIG. 10, disclosed is another embodiment of a shower head applied with above said oscillator, bottom bodies 16 of the plurality of oscillators are directly in integral formed in the faceplate 60 of the shower head, the top body 15 of the corresponding oscillator is embedded to the bottom body 16 to form a shower head with oscillating water outlet function.

The faceplate 60 of the shower head is disposed with an annular cavity 61, the bottom bodies 16 of the four oscillators are ring array arranged inside the annular cavity 61 in once forming, the periphery wall of the bottom body 16 extends upwardly to form an accommodating space of the top body 15, the top body 15 is embedded in the accommodating space, the oscillating cavity is formed between the top body 15 and the bottom body 16, the inlet 11 is disposed in the top body 15, the outlet 13 is disposed in the bottom body 16, the front end of the outlet 13 is concaved and disposed in the outlet surface 62 of the faceplate 60.

The inlet 11 is straight tube shaped, the inner diameter of the outlet 13 is gradually increased along the outlet direction, the end of the outlet 13 near to the oscillating cavity 12 is larger than the inner diameter of the inlet 11. the ratio of the inner diameter of the inlet 11, the inner diameter of the oscillating cavity 12 and the minimum inner diameter of the outlet 13 is 1:3:1.2. in this condition, it has well oscillating effect, high oscillating frequency and strong spray vigor.

When used, as the water oscillating effect is cyclical conical, and the shower heads sprays large granule water, the shower head with the plurality of oscillators can outlet spraying water and massage water; it can achieve ideal shower area even the oscillators are arranged in a small area, this embodiment is configured with four oscillators in the center of the faceplate in ring arrangement; with the several oscillating outlets, it has better visual effect than that applied with single outlet. A plurality of oscillators or a plurality round of the oscillators are available as needed.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

What is claimed is:

1. Showerhead with oscillating water, comprising:
an inlet passage,
an outlet passage connected to the inlet passage,
an oscillator assembled inside the shower head, said oscillator having a main body (10) with an inlet (11), a ball shaped oscillating cavity (12) and an outlet (13) that are connected one by one, wherein the ratio of the inner diameter of the inlet (11), the inner diameter of the oscillating cavity (12) and the minimum inner diameter of the outlet (13) being 1:2.5-5:1.1-1.35, water of the inlet (11) flowing into the oscillating cavity (12) scattering and dividing into a main waterway and a feedback waterway, water of the main waterway flowing out of the outlet (13) through the oscillating cavity (12), water of the feedback waterway flowing back to the inlet (11) through the cavity wall of the oscillating cavity (12), water of the main waterway flowing out of the outlet (13) in a circumferential cyclical shaking way under the compact of the water of the feedback waterway,
the inlet (11) is connected to the inlet passage, the outlet (13) is connected to the outlet passage.

2. Showerhead with oscillating water according to claim 1, wherein the ratio of the inner diameter of the inlet (11), the inner diameter of the oscillating cavity (12) and the minimum inner diameter of the outlet (13) is 1:3:1.2.

3. Showerhead with oscillating water according to claim 1, wherein the inlet (11) is straight tube shaped, the inner diameter of the outlet (13) is gradually increased along the outlet direction, the inner diameter of the outlet (13) near to the oscillating cavity (12) is larger than the inner diameter of the inlet (11).

4. Showerhead with oscillating water according to claim 1, wherein the connecting portion of the inlet (11) near to the oscillating cavity (12) connected to the oscillating cavity (12) is disposed with circular transition.

5. Showerhead with oscillating water according to claim 1, wherein the main body (10) comprising a top body (15) and a bottom body (16) that form the oscillating cavity (12), the inlet (11) is disposed in the top body (15), the outlet (13) is disposed in the bottom body (16).

6. Showerhead with oscillating water according to claim 5, wherein the top body (15) is disposed with a groove (17), the bottom body (16) is disposed with a boss (18), the boss (18) is inserted into the groove (17), the bottom surface of the groove (17) is tightly contacted with the top surface of the boss (18).

7. Showerhead with oscillating water according to claim 6, wherein the side wall of the groove (17) is disposed with a lock groove (20), the side surface of the boss (18) is disposed with a lock block (30) coupled to the lock groove (20) to lock to the lock groove (20), with the lock connection of the lock groove (20) and the lock block (30), the top body (15) is assembled to the bottom body (16).

8. Showerhead with oscillating water according to claim 1, wherein the inner diameter of the inlet (11) is 1.2-3.5 mm.

9. Showerhead with oscillating water according to claim 1, wherein comprising at least two oscillators that are ring array arranged.

10. Showerhead with oscillating water according to claim 1, wherein the oscillator is disposed inside a faceplate (60) of the shower head, the main body (10) comprise a bottom body (16) and a top body (15), the bottom body (16) and the faceplate (60) are in integral forming directly, the corresponding top body (15) of the oscillator is embedded to the bottom body (16) to form a shower head with oscillating water outlet function.

11. Showerhead with oscillating water according to claim 10, wherein the faceplate (60) of the shower head is disposed with a ring cavity (61), the bottom body (16) with a plurality of oscillators are ring array arranged inside the ring cavity (61) and are in integral forming, a periphery wall of the bottom body (16) extends upwardly to form an accommodating space of the top body (15), the top body (15) is embedded in the accommodating space.

12. Showerhead with oscillating water according to claim 11, wherein the oscillating cavity (12) is formed between the top body (15) and the bottom body (16), the inlet (11) is disposed in the top body (15), the outlet (13) is disposed in the bottom body (16), an front end of the outlet (13) is concaved and disposed on an outlet surface (62) of the faceplate (60).
